(19) United States
(12) Patent Application Publication
(10) Pub. No.: US 2009/0009332 A1
(43) Pub. Date: Jan. 8, 2009

(54) SYSTEM AND METHOD FOR MONITORING INGESTED MEDICATION VIA RF WIRELESS TELEMETRY

(75) Inventors: Anthony I. Nunez, Beachwood, OH (US); Harry D. Rowland, Peoria, IL (US)

Correspondence Address: Patent Docket Department;Armstrong Teasdale LLP, One Metropolitan Square, Suite 2600, St. Louis, MO, 63102-2740, US

(73) Assignee: ENDOTRONIX, INC., Peoria, IL (US)

(21) Appl. No.: 12/167,050

(22) Filed: Jul. 2, 2008

Related U.S. Application Data
(60) Provisional application No. 60/947,913, filed on Jul. 3, 2007.

(51) Int. Cl. G08B 13/22

(52) U.S. Cl. 340/572.1

(57) ABSTRACT

A radio frequency identification (RFID) tag device for monitoring at least one of ingestion and digestion by a subject of a solid dosage form includes a substrate attachable to the solid dosage form or at least partially embedded into the surface of the solid dosage form and an RFID tag at least partially formed on the substrate. The RFID tag is configured to generate a signal and transmit the generated signal to an external receiver to facilitate monitoring at least one of ingestion and digestion by the subject of the solid dosage form.

### CROSS REFERENCE TO RELATED APPLICATIONS

This application claims the benefit of U.S. Provisional Application No. 60/947,913, filed Jul. 3, 2007, which is hereby incorporated by reference in its entirety.

### BACKGROUND OF THE INVENTION

The subject matter disclosed herein relates generally to monitoring ingestion and/or digestion of medication and, more particularly, to a system and a method for monitoring ingestion and/or digestion of medication utilizing radio frequency identification (RFID) tags attached to, or printed on or at least partially in a surface of medication in a solid dosage form, such as a capsule, a tablet, or a pill.

Wireless patient health monitoring is critical to improving healthcare. Wireless patient health monitoring enables continuous, personalized, at-home monitoring that reduces costly hospital admissions and improves a patient's quality of life. The ability to monitor the ingestion and digestion of medications as prescribed by a physician can further improve healthcare. For example, the ability to monitor medicine ingestion into the body is useful for verifying proper usage, monitoring drug interactions, controlling dosage, and maintaining inventory control. Further, the ability to monitor medicine digestion is useful for verifying the efficacy of a prescribed medication to a particular patient.

Non-compliance of patients to prescribed drug regimens critically limits the ability of a physician to properly diagnose and treat a patient's condition. Non-compliance includes the intentional or unintentional failure to take the prescribed dosage at the prescribed time, which may result in undermedication or overmedication. Non-compliance may also result in increased cost of medical care, higher complication rates, and/or drug wastage.

Better monitoring of an actual drug intake time and digestion may assist in resolving issues related to medication non-compliance. For example, blood levels may be corrected for an actual drug intake time to facilitate pharmacokinetic/pharmacodynamic interpretations rather than relying on an assumed or an approximate time when a patient was scheduled to take the medication. Monitoring of drug compliance may also improve the process of drug development during clinical trials. During a clinical drug stage, accurately measuring compliance may improve the statistical reliability of a clinical study. During a therapeutic drug stage, accurately measuring compliance may assist in identifying the side effects related to underdosing or overdosing.

Conventional methods for monitoring drug compliance are limited by efficacy and cost of implementation. Many conventional methods for monitoring drug intake and compliance largely rely on direct observation by trained persons, blood or urine analysis, or transdermal detection of fluorescent tags. More recently, RFID technology has been applied to medication monitoring by affixing RFID tags to containers for medicine, patients, and medicine dispensers. These RFID tags can be remotely queried in order to track medicine usage. One major shortcoming of this approach is that the RFID tag is applied to the container and not in the medicine that is ingested. Therefore, conventional monitoring is largely conjectural, and based on a time that the drug container is opened or activated rather than when the drug is ingested. Although usage can be tracked, a method that verifies ingestion and digestion of medicine by a subject has not been implemented.

Recent efforts to monitor medication compliance include RFID tags that enter the gastrointestinal system and are modified by the gastrointestinal system. A change in a signal from the RFID tag caused by the effects of the gastrointestinal system can indicate ingestion or digestion of medication. A conventional method includes inserting RFID tags inside a digestible capsule, tablet, or pill. After the capsule, tablet, or pill dissolves or disassociates within the gastrointestinal system, the signal from the RFID tag changes to indicate that the RFID tag is in the gastrointestinal system. Other conventional methods for monitoring medication compliance include a digestible RFID tag that breaks up within the gastrointestinal system when the medicine is processed, resulting in a loss of the RFID signal and, thus, an indication that the medicine has been digested. Another conventional electronic pill includes an RFID tag on the surface of a drug delivery device. The RFID signal is modified inside the gastrointestinal system, thus signaling ingestion of medication. These methods require the creation of new drug transporting mechanisms. Further, these methods do not provide a manufacturing process to attach the RFID tag to the drug transporting mechanisms. Rather, these methods require the development of costly manufacturing methods to fabricate new capsules, tablets, or pills.

### BRIEF DESCRIPTION OF THE INVENTION

In one aspect, a radio frequency identification (RFID) tag device for monitoring at least one of ingestion and digestion by a subject of a solid dosage form is provided. The RFID tag device includes a substrate attachable to the solid dosage form or at least partially embedded into an outer surface of the solid dosage form and an RFID tag at least partially formed on the substrate. The RFID tag is configured to generate a signal and transmit the generated signal to an external receiver to facilitate monitoring at least one of ingestion and digestion by the subject of the solid dosage form.

In another aspect, a system for monitoring at least one of ingestion and digestion by a subject of a solid dosage form is provided. The system includes a substrate attached to the solid dosage form or at least partially embedded into an outer surface of the solid dosage form and a radio frequency identification (RFID) tag device at least partially formed on the substrate. The RFID tag device includes an RFID tag configured to generate a signal and transmit the generated signal to an external receiver to facilitate monitoring at least one of ingestion and digestion by the subject of the solid dosage form.

In another aspect, a method is provided for monitoring at least one of ingestion and digestion by a subject of a solid dosage form. The method includes attaching a radio frequency identification (RFID) tag to a solid dosage form or at least partially embedding the RFID tag into an outer surface of the solid dosage form and detecting a change in a signal generated by the RFID tag after ingestion of the solid dosage form.

In yet another aspect, a method is provided for manufacturing a solid dosage form for monitoring at least one of ingestion and digestion by a subject of the solid dosage form. The method includes forming an antenna on a substrate. A radio frequency identification (RFID) tag including the antenna is formed. The RFID tag is configured to receive interrogation signals from an external transmitter and generate a response signal that is transmitted to an external receiver such that the response signal can be monitored. The substrate is attached to the solid dosage form or at least partially embedded into an outer surface of the solid dosage form.

### BRIEF DESCRIPTION OF THE DRAWINGS

FIG. 1 is a first plan view of a medication in a solid dosage form and an exemplary RFID tag device attached to an outer surface of the medication;

FIG. 2 is a partial section view of the exemplary RFID tag device shown in FIG. 1 attached to the medication;

FIG. 3 is a first perspective view of a medication in a solid dosage form and an alternative exemplary RFID tag attached to an outer surface of the medication;

FIG. 4 is a second perspective view of the medication and the alternative exemplary RFID tag shown in FIG. 3;

FIG. 5 is a perspective view of the alternative exemplary RFID tag shown in FIG. 3 in a flat configuration;

FIG. 6 is a perspective view of a medication in a solid dosage form and an exemplary RFID tag attached to an outer surface of the medication;

FIG. 7 is a side view of the medication and the exemplary RFID tag shown in FIG. 6;

FIG. 8 is a perspective view of a medication in a solid dosage form and an exemplary RFID tag attached to an outer surface of the medication;

FIG. 9 is an exploded perspective view of the medication and the exemplary RFID tag shown in FIG. 8;

FIGS. 10-13 are side views of exemplary RFID tag devices suitable for attachment to a solid dosage form;

FIG. 14 is a side view of an exemplary RFID tag devices;

FIGS. 15-17 show an exemplary printing process to attach an exemplary RFID tag device on a substrate to a medication in a solid dosage form;

FIG. 18 is a side view of an exemplary RFID tag device on a substrate attached to a medication in a solid dosage form;

FIG. 19 is a side view of an exemplary RFID tag device showing changes or modifications to the RFID tag device after ingestion by a subject;

FIG. 20 is a side view of an exemplary RFID tag device showing a break up of the RFID tag after digestion by a subject;

FIGS. 21-26 show an exemplary apparatus and method for forming an RFID tag device including one or more coating layers and applying the RFID tag device to a medication in a solid dosage;

FIGS. 27-33 show an alternative exemplary method for forming an RFID tag directly on a medication in a solid dosage form;

FIGS. 34-36 schematically show an exemplary system and method for identifying ingestion and digestion of a medication;

FIG. 37 schematically shows an exemplary system and method for identifying a medication prior to ingestion;

FIG. 38 schematically shows an exemplary system and process for identifying ingestion by a subject of a solid dosage form; and

FIG. 39 schematically shows an exemplary system and process for identifying digestion by a subject of a solid dosage form.

### DETAILED DESCRIPTION OF THE INVENTION

The present disclosure is directed to a production-scalable, cost-effective system and method for wirelessly monitoring ingestion and/or digestion by a subject, such as a patient, of a medication in a solid dosage form including, for example, a capsule, a pill or a tablet, without significantly modifying the medication. In one embodiment, a system and a method utilizes a printing process to attach or couple a radio frequency identification (RFID) tag device to a medication in a sold dosage form, such as a capsule, a tablet, or a pill, that is designed to disassociate within a subject's gastrointestinal system. The RFID tag device includes an RFID tag configured to receive radio frequency (RF) signals, such as interrogation signals, from a transmitter, such as an external transmitter, and generate and transmit RF response signals to a receiver, such as an external receiver. The RFID tag device may include one or more RFID tags that react within the gastrointestinal system in a detectable manner. The RFID tags may be printed at least partially onto the medication. In an alternative embodiment, the RFID tag devices are attached or coupled to a medication using a suitable process, such as a printing process that accurately positions and deposits precise components in and/or on a surface of the medication without altering the composition of the medication. As a result, RFID tag devices are cost-effectively mass produced on medications without altering the medication. As used herein, references to an “RFID tag” are to be understood to refer to a series resonant circuit, a tank circuit, and/any suitable wirelessly identifiable electronic circuit.

When the ability to monitor medication ingestion and digestion is combined with the ability to directly monitor physiological function, it is possible to improve the diagnosis and treatment of a patient's condition. For example, a physician may monitor the function of the patient's heart in real-time using an implanted wireless pressure monitor. The monitoring of the functioning of the heart can improve treatment of disorders such as congestive heart failure. When a physician can monitor the functioning of the heart in real-time prior to, during, and after ingestion and digestion of medication, a physician can make a better informed decision to alter the dosage, timing, and/or type of medication for a patient.

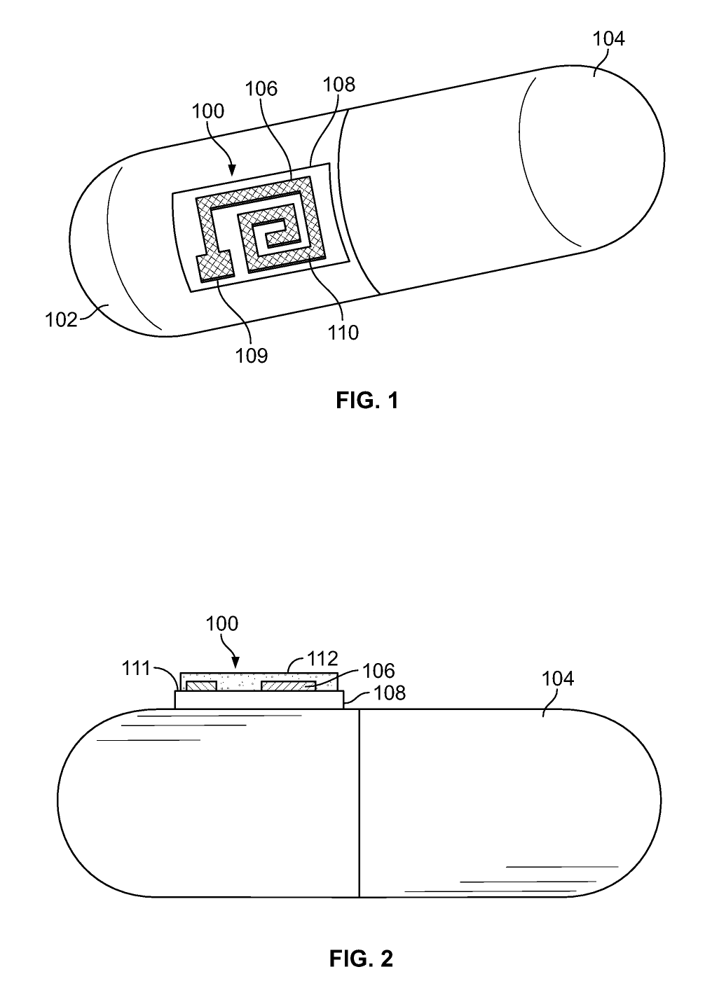

FIG. 1 shows a first view of an exemplary radio frequency identification (RFID) tag device 100 attached or coupled to an outer surface 102 of a medication in a solid dosage form, such as a medication capsule 104. In a particular embodiment, at least a portion of RFID tag device 100 is at least partially embedded within outer surface 102. In one particular embodiment, RFID tag device 100 is only partially embedded within outer surface 102. RFID tag device 100 includes an RFID tag 106 attached or coupled to a substrate 108, which is attached or coupled to outer surface 102 of medication capsule 104. In a particular embodiment, RFID tag 106 includes a capacitor 109 and an antenna/inductor coil 110 in a suitable electrical configuration. In one embodiment, substrate 108 dissolves or disintegrates after a period of time in a patient's gastrointestinal system. The dissolution or disintegration of substrate 108 results in a breakup, such as a disassociation, dissolution or disintegration, of RFID tag 106. In an alternative embodiment, RFID tag 106 is applied directly on or at least partially within outer surface 102 of medication capsule 104 by a suitable printing process including, without limitation, a transfer printing, contact printing, laminating, and/or stamping printing process. In a particular embodiment, at least one surface, such as surface 111 of substrate 108 is textured with a controlled topography to facilitate attaching RFID tag device 100 on or at least partially within outer surface 102 of medication capsule 104. FIG. 2 shows a cross-sectional view of RFID tag device 100 attached to outer surface 102 of medication capsule 104. RFID tag device 100 includes substrate 108, RFID tag 106, and at least one coating layer 112 applied to at least a portion of RFID tag 106. In this embodiment, coating layer 112 has electrically conducting or electromagnetically shielding properties such that a signal generated by RFID tag 106 is altered or changed, such as attenuated or temporarily undetectable, before coating layer 112 is modified, such as dissolved or absorbed, within the patient's gastrointestinal system.

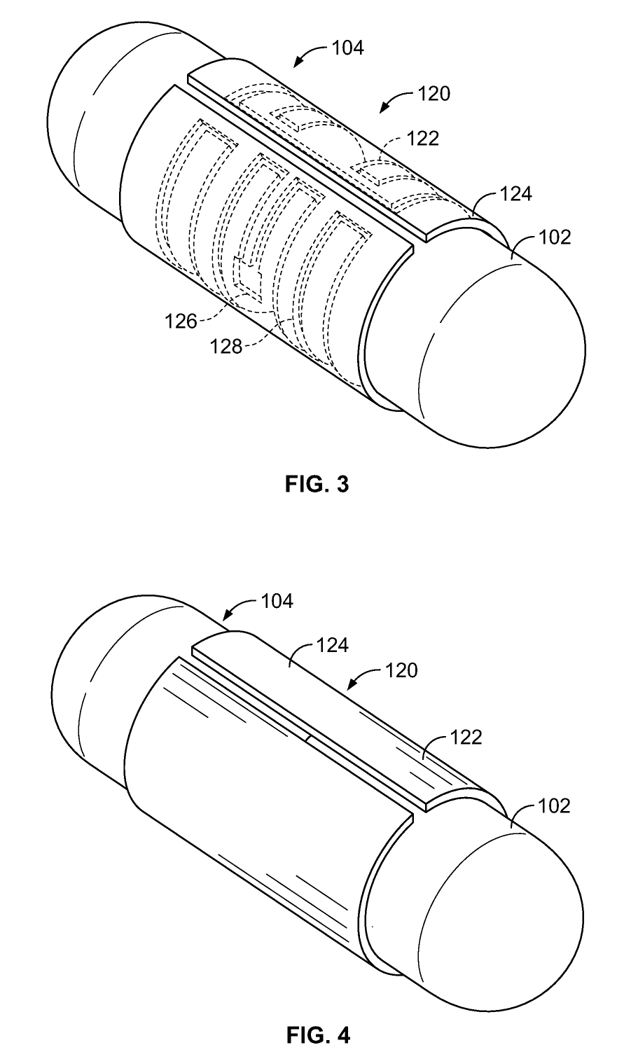

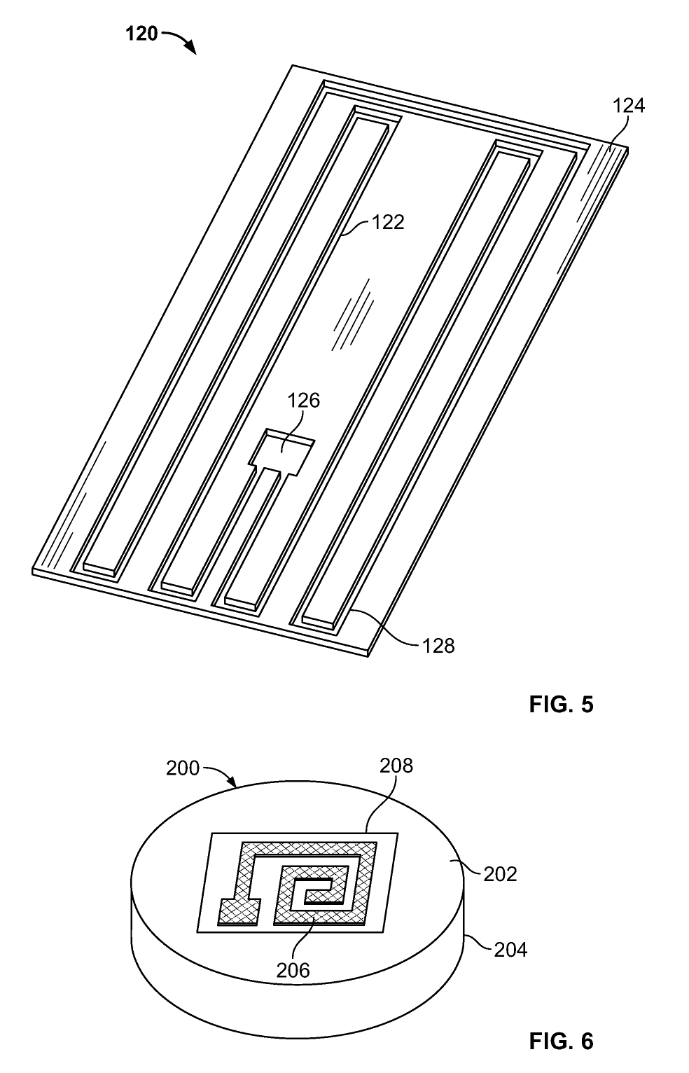

FIGS. 3 and 4 are perspective views of an alternative RFID tag device 120 positioned about and attached or coupled to outer surface 102 of medication capsule 104. In a particular embodiment, at least a portion of RFID tag device 120 is at least partially embedded within outer surface 102. In one particular embodiment, RFID tag device 120 is only partially embedded within outer surface 102. RFID tag device 120 is made of suitably flexible material such that RFID tag device 120 is positionable about medication capsule 104. RFID tag device 120 includes an RFID tag 122 that is attached or coupled to a substrate 124, which is positioned about at least a portion of outer surface 102 of medication capsule 104. In a particular embodiment, substrate 124 is degradable and RFID tag 122 includes a capacitor 126 and an antenna/inductor coil 128 in a parallel electrical configuration, as shown in FIG. 4. In one particular embodiment, the degradation of substrate 124 does not result in breakup of RFID tag 122 but rather the RFID tag signal becomes attenuated in the bodily fluid environment due to the degradation of substrate 124. FIG. 5 shows RFID tag device 120 in a generally flat configuration prior to being positioned about medication capsule 104, for example.

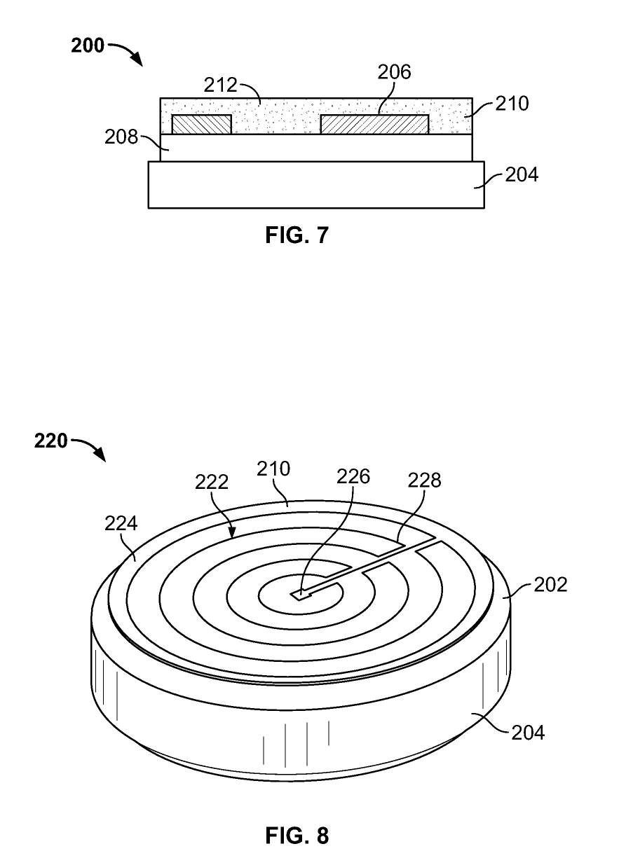

FIG. 6 shows a perspective view of an exemplary RFID tag device 200 attached or coupled to an outer surface 202 of a medication in a solid dosage form, such as a medication tablet 204. In a particular embodiment, at least a portion of RFID tag device 200 is at least partially embedded within outer surface 202. RFID tag device 200 includes an RFID tag 206 attached or coupled to a substrate 208, which is attached or coupled to outer surface 202 of medication tablet 204. In one embodiment, substrate 208 dissolves or disintegrates after a period of time in a patient's gastrointestinal system. The dissolution or disintegration of substrate 208 results in a breakup, such as a disassociation, dissolution or disintegration, of RFID tag 206. In an alternative embodiment, the degradation of substrate 208 does not result in breakup of RFID tag 206 but rather the RFID tag signal becomes attenuated in the bodily fluid environment due to the degradation of substrate 208. In an alternative embodiment, RFID tag 206 is applied directly on or at least partially within outer surface 202 of medication tablet 204 by a suitable printing process including, without limitation, a transfer printing, contact printing, laminating, and/or stamping printing process. In a particular embodiment, a surface 210 of substrate 208 is textured with a controlled topography to facilitate attaching RFID tag device 200 to or at least partially within outer surface 202 of medication tablet 204. FIG. 7 shows a cross-sectional view of RFID tag device 200 attached to outer surface 202 of medication tablet 204. RFID tag device 200 includes RFID tag 206, substrate 208, and at least one coating layer 212 applied to at least a portion of RFID tag 206. In this embodiment, coating layer 212 has electrically conducting or electromagnetically shielding properties such that a signal generated by RFID tag 206 is altered or changed, such as attenuated or temporarily undetectable, before coating layer 212 is modified, such as dissolved or absorbed, within the patient's gastrointestinal system.

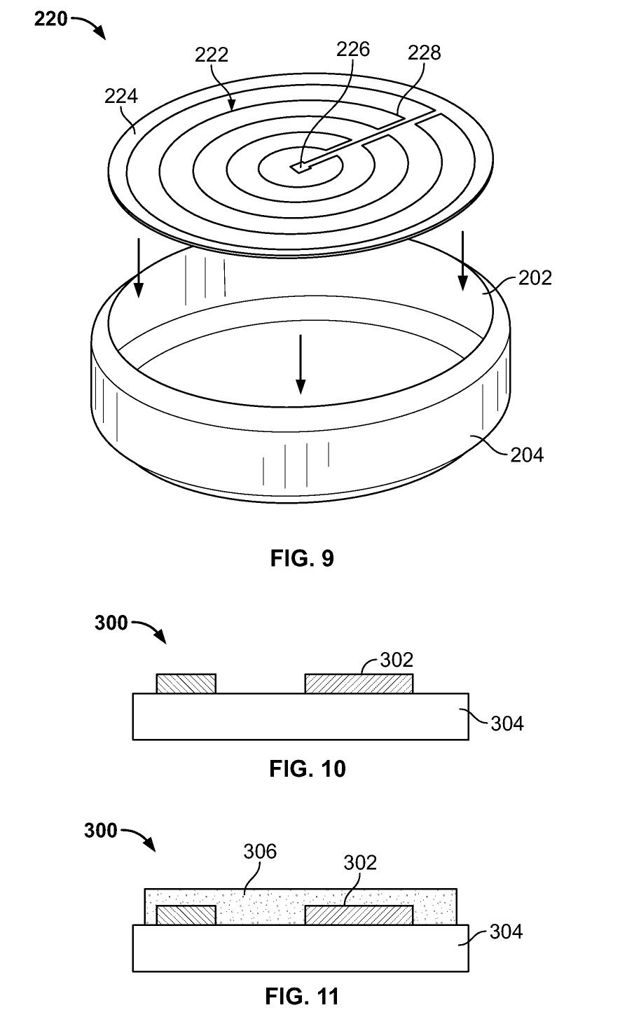

FIG. 8 shows a perspective view of an exemplary RFID tag device 220 attached or coupled to an outer surface 202 of a medication in a solid dosage form, such as medication tablet 204. FIG. 9 is an exploded perspective view of RFID tag device 220 and medication tablet 204. RFID tag device 220 includes an RFID tag 222 that is attached or coupled to a substrate 224, which is attached or coupled to outer surface 202 of medication tablet 204. In one embodiment, substrate 224 is degradable and RFID tag 222 includes a capacitor 226 and an antenna/inductor coil 228 in a parallel electrical configuration. In a particular embodiment, at least a portion of RFID tag device 220 is at least partially embedded within outer surface 202. In one particular embodiment, RFID tag device 220 is only partially embedded within outer surface 202.

Substrate 224 dissolves or disintegrates after a period of time within the patient's gastrointestinal system. In this embodiment, the dissolution or disintegration of substrate 224 results in a breakup, such as a disassociation, dissolution or disintegration, of RFID tag 222. RFID tag device 220 is attached or coupled to outer surface 202 of medication tablet 204 by a suitable printing process including, without limitation, a transfer printing, contact printing, laminating, and/or stamping printing process. In a particular embodiment, a surface 230 of substrate 224 is textured with a controlled topography to facilitate attaching RFID tag device 220 on or at least partially within outer surface 202 of medication tablet 204.

Referring further to FIGS. 8 and 9, in one embodiment RFID tag device 220 includes RFID tag 222, substrate 224, and at least one coating layer 228 applied to at least a portion of RFID tag 222. In a particular embodiment, coating layer 228 has electrically conducting or electromagnetically shielding properties such that a signal generated by RFID tag 222 is altered or changed, such as attenuated or temporarily undetectable, before coating layer 212 is modified, such as dissolved or absorbed, within the patient's gastrointestinal system.

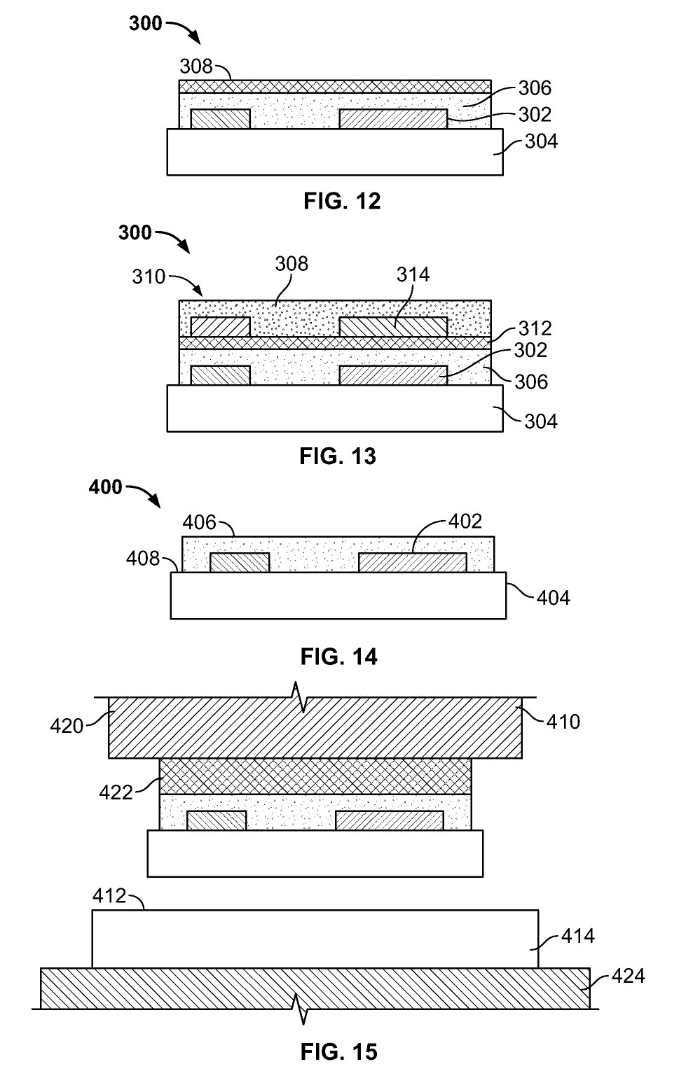

FIGS. 10-13 show exemplary embodiments of an RFID tag device 300 prior to attachment onto or at least partially within an outer surface of a solid dosage form, such as medication capsule 104 or medication tablet 204, for example. FIG. 10 shows a side view of RFID tag device 300 including an RFID tag 302 attached or coupled to a substrate 304. FIG. 11 shows RFID tag device 300 including RFID tag 302 attached or coupled to substrate 304 and a first coating layer 306 applied to at least a portion of RFID tag 302. FIG. 12 shows RFID tag device 300 including RFID tag 302 attached or coupled to substrate 304, first coating layer 306, and an additional or second coating layer 308 applied to at least a portion of first coating layer 306. In a particular embodiment, one or more interfacial layers may be deposited below, on, and/or between RFID tag 302, substrate 304, first coating layer 306 and/or second coating layer 308. FIG. 13 shows RFID tag device 300 prior to attachment to a medication in a solid dosage form, such as a capsule, a tablet, or a pill, including a multiple RFID tag assembly 310. Multiple RFID tag assembly 310 includes RFID tag 302, substrate 304, first coating layer 306, an interfacial layer 312, an additional RFID tag 314 preferably the same or similar to RFID tag 302, and second coating layer 308. In one embodiment, second coating layer 308 is modified within the gastrointestinal system before first coating layer 306 is modified within the gastrointestinal system such that additional RFID tag 314 generates a signal that is transmitted to an external receiver indicative of ingestion by the subject of the medication to which multiple RFID tag assembly 310 is coupled. After first coating layer 306 is modified within the subject's gastrointestinal system, RFID tag 302 generates a signal that is transmitted to an external receiver indicative of digestion by the subject of the medication to which multiple RFID tag assembly 310 is coupled.

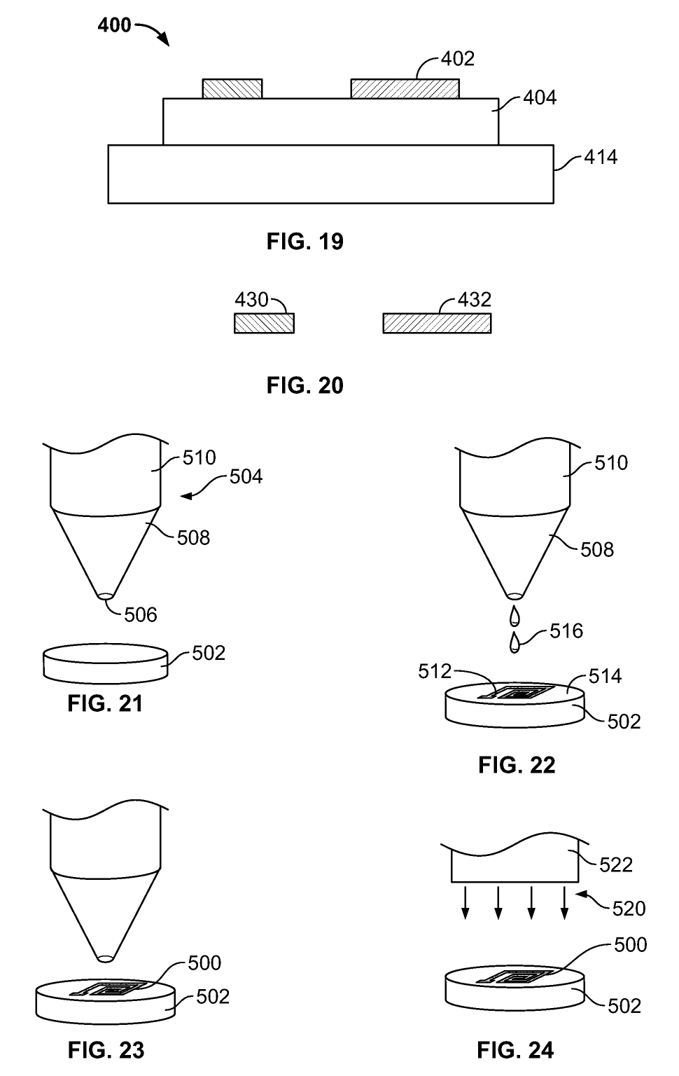

FIG. 14 shows an exemplary RFID tag device 400 fabricated utilizing a suitable printing process. FIGS. 15-18 show schematically an exemplary embodiment of a system and a printing method for attaching or coupling an RFID tag 402 to a substrate 404 and attaching or coupling substrate 404 to a medication having a solid dosage form, such as a medication tablet. FIG. 19 shows a modification or a change to RFID tag device 400 after ingestion by the subject of the medication tablet including RFID tag device 400, and FIG. 20 shows a breakup, such as a disassociation, dissolution or disintegration, of RFID tag 402 after digestion by the subject of the medication tablet including RFID tag device 400. Referring further to FIG. 14, RFID tag device 400, prior to attachment to the medication tablet, includes RFID tag 402 attached or coupled to substrate 404, and a coating layer 406 applied to at least a portion of RFID tag 402. In one embodiment, a surface 408 of substrate 404 is textured with a controlled topography to facilitate attaching RFID tag device 400 to or at least partially within an outer surface of the medication tablet.

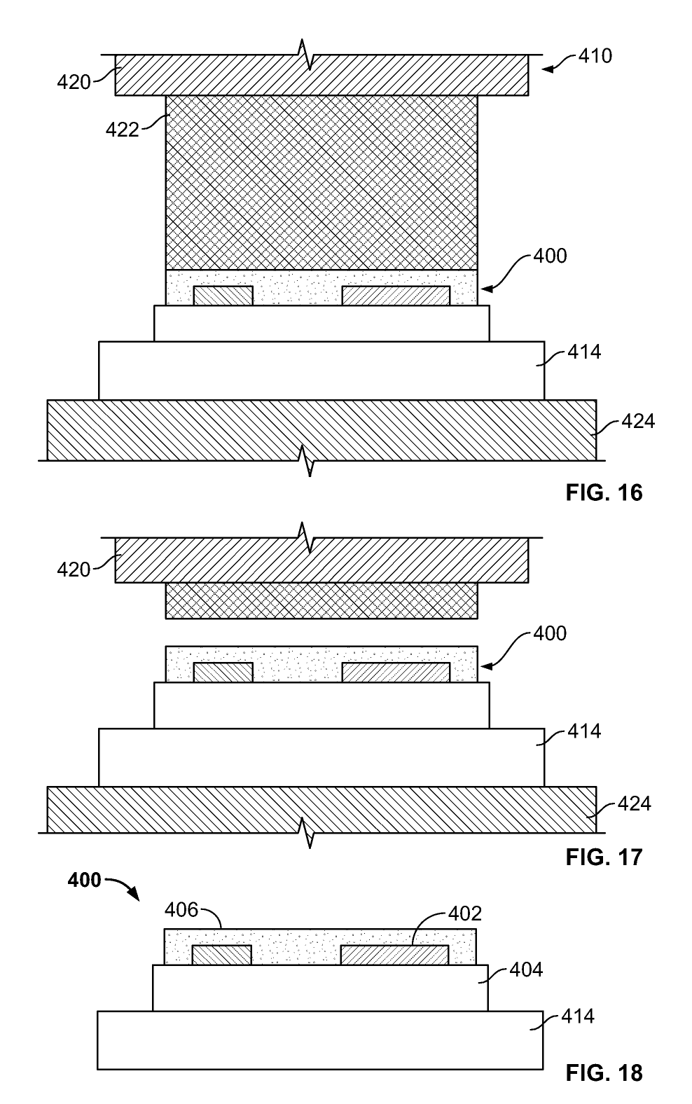

As shown in FIG. 15, a suitable printing machine 410 is configured to print RFID tag device 400 onto or at least partially within an outer surface 412 of a medication tablet 414. Printing machine 410 includes a hollow cylindrical fixture 420 and a shaft 422 movably positioned within cylindrical fixture 420. In one embodiment, RFID tag device 400 adheres to or is otherwise coupled to shaft 422. Medication tablet 414 is positioned below RFID tag device 400 adhered to shaft 422 and medication tablet 414 is supported on a fixture 424. Shaft 422 moved towards medication tablet 414 to press RFID tag device onto or at least partially into outer surface 412 of medication tablet 414, as shown in FIG. 16. In one embodiment, an adhesion strength adhering coating layer 406 to shaft 422 is less than an adhesion strength adhering substrate 404 to outer surface 412 of medication tablet 414 such that, as shaft 422 is moved away from fixture 424, RFID tag device 400 is transferred from shaft 422 to medication tablet 414. In a particular embodiment, a suitable adhesive secures RFID tag device 400 to medication tablet 414. In alternative embodiments, an application of heat, an adhesive, an application of pressure, and/or a combination thereof secures RFID tag device 400 to medication tablet 414. In yet further embodiments, a chemical reaction between a contacting surface of substrate 404 and outer surface 412 of medication tablet 414 secures RFID tag device 400 to medication tablet 414. As shown in FIG. 17, shaft 422 is moved away from medication tablet 414 after pressing RFID tag device 400 onto outer surface 412 of medication tablet 414 and RFID tag device 400 is transferred from shaft 422 to medication tablet 414 during the printing process.

In the exemplary embodiment, the printing process includes a roll-to-roll assembly line process. The medication capsules, tablets, or pills are rapidly placed below printing machine 410 on a roll-to-roll assembly line. RFID tag devices 400 are rapidly placed below printing machine 410 on a separate roll-to-roll assembly line. In one embodiment, RFID tag devices 400 are placed over the medication capsules, tablets, or pills prior to making contact with printing machine 410. In further embodiments, printing machine 410 applies heat and/or pressure to facilitate attaching RFID tag devices 400 onto or at least partially within the medication capsules, tablets, or pills.

FIGS. 18-20 show a modification to medication tablet 414 and RFID tag device 400 during ingestion by a subject of medication tablet 414 including RFID tag device 400 and digestion within the subject's gastrointestinal system of medication tablet 414 including RFID tag device 400. Referring to FIG. 18, RFID tag device 400 is attached to medication tablet 414. RFID tag device 400 includes RFID tag 402 attached or coupled to substrate 404 and coating layer 406. In one embodiment, coating layer 406 has electrically conducting or electromagnetically shielding properties such that a signal generated by RFID tag 402 is altered, such as attenuated or extinguished, before coating layer 406 is modified within the patient's gastrointestinal system. FIG. 19 shows a modification to RFID tag device 400 after medication tablet 414 has entered the patient's gastrointestinal system. Coating layer 406 is removed during the digestion process within the subject's gastrointestinal system upon ingestion of medication tablet 414. The removal of coating layer 406 modifies RFID tag 402 such that RFID tag 402 transmits radio frequency signals to and receives radio frequency signals from an external receiver and an external transmitter to facilitate confirmation that the patient ingested medication tablet 414 ingestion. As shown in FIG. 20, RFID tag device 400 is modified as medication tablet 414 is digested within the patient's gastrointestinal system. Substrate layer 404 and medication tablet 414 are dissolved or disintegrated during the digestion process, resulting in the breakup of RFID tag 402 into disconnected pieces, such as piece 430 and piece 432 of RFID tag 402. The loss or cessation of the signal due to the breakup of RFID tag 402, as determined by the external receiver and/or the external transmitter, facilitates confirming that medication tablet 414 has been digested by the subject.

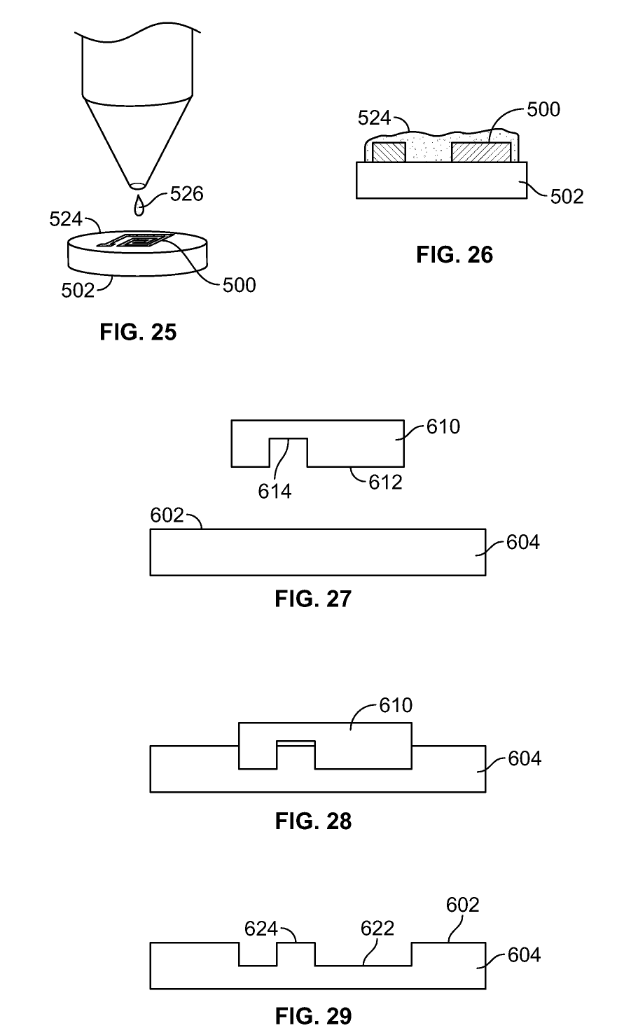

FIGS. 21-26 show an exemplary printing apparatus and method for forming an RFID tag 500 directly on a medication in a solid dosage form, such as a medication tablet 502. Referring to FIG. 21, medication tablet 502 is positioned beneath an ink jet printing device 504 that defines an orifice 506 at a first end of a nozzle 508 coupled to an end portion of a support structure 510. A layer 512 of RFID tag 500 is printed on or applied to a first surface 514 of medication tablet 502, as shown in FIG. 22. In one embodiment, surface 514 is electrically conducting. In alternative embodiments, surface 514 is a precursor to an electrically conducting layer and is made to be electrically conducting using suitable subsequent processing steps including, without limitation, application of thermal radiation and/or ultraviolet radiation. In a particular embodiment, surface 514 includes a patterned layer constructed from a raster scanning nozzle 508 while selectively jet printing droplets of ink 516. FIG. 23 shows a fully-printed or complete RFID tag 500 on medication tablet 502. A post-processing step as shown in FIG. 24 may be utilized to cure RFID tag 500 with ultraviolet radiation and/or thermal radiation, as represented by arrows 520. The ultraviolet radiation and/or thermal radiation is emitted from a suitable radiation source 522 known to those skilled in the art and guided by the teachings herein provided. As shown in FIG. 25, a coating layer 524 is formed on RFID tag 500 by ink jet printing droplets 526 of a suitable coating material. In alternative embodiments, RFID tag 500 and/or coating layer 524 may be printed using any suitable printing process including, without limitation, a screen printing, laminating, transfer printing, impact printing, stamping, roll-to-roll printing, contact printing, spin coating, casting, gravure printing, roll coating, gap coating, rod coating, extrusion coating, dip coating, curtain coating, air knife coating, and/or laser writing process. FIG. 26 shows a sectional view of RFID tag 500 directly printed on medication tablet 502 and coating layer 524 at least partially coating RFID tag 500.

FIGS. 27-33 show a printing process according to an alternative embodiment for forming an RFID tag 600 at least partially in a surface 602 of a medication in solid dosage form, such as a medication tablet 604. Referring to FIG. 27, a patterned mold or stamp structure 610 includes one or more raised features 612 and one or more recessed features 614 to facilitate forming RFID tag 600. Mold 610 is positioned with respect to medication tablet 604 and, as shown in FIG. 28, is pressed into medication tablet 604. In one embodiment, mold 610 and/or medication tablet 604 are heated while mold 610 is pressed into medication tablet 604 to facilitate forming RFID tag 600 without damaging medication tablet 604. FIG. 29 shows medication tablet 604 after mold 610 is removed from surface 602 to form recessed features 622 and raised features 624 at least partially on or within surface 602 of medication tablet 604. More specifically, raised features 612 of mold 610 form corresponding recessed features 622 at least partially on or within surface 602 while recessed features 614 of mold 610 form corresponding raised features 624 at least partially on or within surface 602 of medication tablet 604.

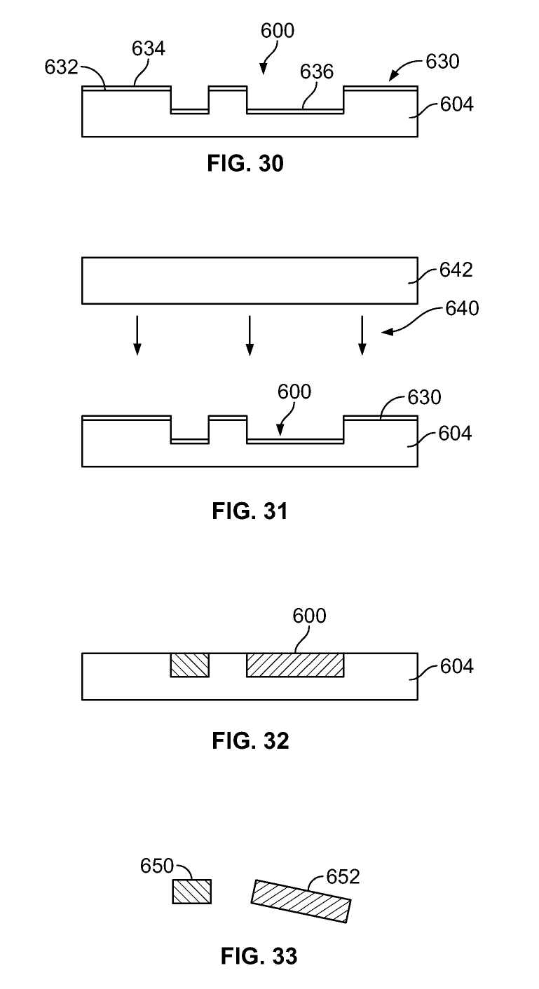

As shown in FIG. 30, a suitable material 630 is applied to or deposited on patterned medication tablet 604 to facilitate forming RFID tag 600. Material 630 may be printed on patterned medication tablet 604 using any suitable printing process including, without limitation, a screen printing, laminating, transfer printing, impact printing, stamping, roll-to-roll printing, contact printing, spin coating, casting, gravure printing, roll coating, gap coating, rod coating, extrusion coating, dip coating, curtain coating, air knife coating, and/or laser writing process. In one embodiment, material 630 is electronically conducting. In alternative embodiments, material 630 is a precursor to an electrically conducting layer and is made electrically conducting using one or more suitable subsequent processing steps including, without limitation, a thermal radiation and/or an ultraviolet radiation process. In one embodiment, material 630 is deposited on patterned medication tablet 604 to form a non-continuous material layer 632 having one or more raised regions 634 and one or more discontinuous recessed regions 636. In this embodiment, recessed regions 636 of material layer 632 form RFID tag 600 and raised regions 634 of material layer 632 are configured to interfere with and/or attenuate a signal generated by RFID tag 600. In a particular embodiment, as shown in FIG. 31, material layer 632 is cured in a post-processing step with ultraviolet radiation and/or thermal radiation, as represented by arrows 640, emitted from a suitable radiation source 642 known to those skilled in the art and guided by the teachings herein provided.

Referring further to FIGS. 32 and 33, medication tablet 604 and attached RFID tag 600 are modified during ingestion by the subject and/or digestion within the subject's gastrointestinal system. Medication tablet 604 is partially dissolved or disintegrated after entering the subject's gastrointestinal system, resulting in the breakup, such as a disassociation, dissolution or disintegration, of raised regions 634. The breakup of raised regions 634 modifies RFID tag 600 such that RFID tag 600 transmits a radio frequency signal to an external receiver and transmitter (not shown) to indicate that the subject has ingested medication tablet 604. As shown in FIG. 33, RFID tag 600 is modified after medication tablet 604 has been digested within the subject's gastrointestinal system. Medication tablet 604 is dissolved or disintegrated within the gastrointestinal system and results in the breakup of RFID tag 600, such as into disconnected pieces 650 and 652. In an alternative embodiment, the degradation of medication tablet 604 does not result in breakup of RFID tag 600 but rather the RFID tag signal becomes attenuated in the bodily fluid environment due to the degradation of medication tablet 604. A change in or cessation of the signal generated by RFID tag 600 as determined by the external receiver and transmitter confirms digestion by the subject of medication tablet 604.

In one embodiment, a pH dependent, timed exposure of the RFID coil is created to facilitate confirming ingestion and/or digestion of oral medicine, such as medication in a solid dosage form. Oral drug delivery represents approximately 32% of an estimated $245 billion pharmaceutical market. The dissolution rates of drugs with poor water solubility can be greatly enhanced by the use of absorption enhancers for the gastrointestinal (GI) tract which in turn improves drug bioavailability and efficacy. Absorption rates may be altered by using controlled release formulations to increase or decrease a drug residence time and gastrointestinal site targeting can also be addressed either as an absorption window or local therapy.

Various enteric materials, such as cellulose acetate phthalate, hydroxypropyl methylcellulose phthalate, polyvinyl acetate phthalate, and the Eudragit® acrylic polymers, have been used as gastroresistant, enterosoluble coatings for single drug pulse release in the intestine. The enteric materials, which are soluble at higher pH values, are frequently used for colon-specific delivery systems. Due to their pH-dependent attributes and the uncertainty of gastric retention time, in-vivo performance as well as inter-subject and intra-subject variability are major issues for using enteric coated systems as a time-controlled release of drugs.

The modifying component of the protective layer used over the enteric coating can include a water penetration barrier layer (semi-permeable polymer) which can be successively coated after the enteric coating to reduce a water penetration rate through the enteric coating layer and, thus, increase a lag time of the drug release. Sustained-release coatings known to those skilled in the art may be used for this purpose in conventional coating techniques, such as pan coating or fluid bed coating, using solutions of polymers in water or suitable organic solvents or by using aqueous polymer dispersions. Suitable materials include, without limitation, cellulose acetate, cellulose acetate butyrate, cellulose acetate propionate, ethyl cellulose, fatty acids and their esters, waxes, zein, and aqueous polymer dispersions such as Eudragit RS and RL 30D, Eudragit NE 30D, Aquacoat, Surelease, and cellulose acetate latex. A combination of one or more of the above polymers and hydrophilic polymers such as hydroxyethyl cellulose, hydroxypropyl cellulose (Klucel, Hercules Corp.), hydroxypropyl methylcellulose (Methocel, Dow Chemical Corp.), polyvinylpyrrolidone may also be used.

A “pill within a pill” embodiment includes an internal pill having an RFID tag surrounded by an external pill with an outer RFID tag coated with a timed release substance that is sensitive to the GI pH, such as an Eudragit L100 copolymer that will dissolve in acidic conditions. The inner pill is also surrounded by an outer substance that maybe pH sensitive and, more specifically, sensitive to an alkaline environment and, thus, the inner RFID tag is only exposed with the medication in a small intestine environment. As a result, an activity of the medication can be monitored by tracking transit and digestion of the medication.

Further, drug delivery can be accurately timed to tailor drugs to a patient's circadian rhythm. Actuation and stimulation may be accomplished through heating, electrical pulse stimulation, and/or local magnetic flux stimulation generated by the RF coil of the RFID tag device. A feed back loop may be created to internal sensors monitoring blood pressure and intracardiac pressure, as well as other internal organ functions. This feed back loop may be automated to enhance disease management.

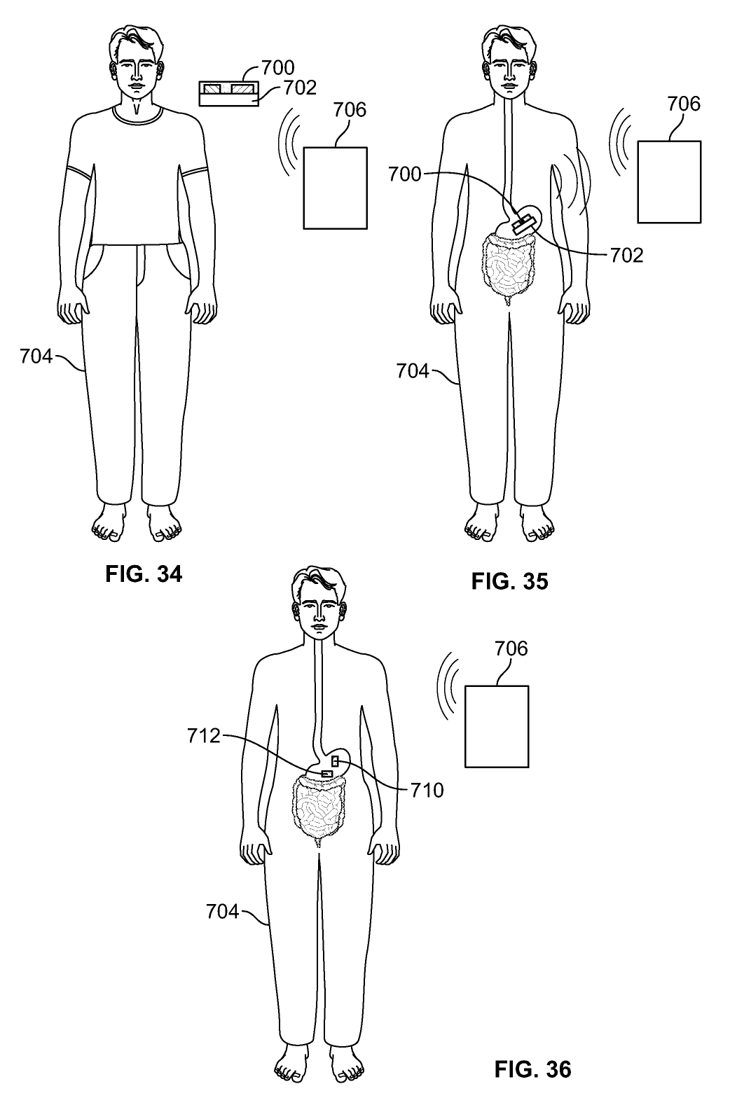

FIGS. 34-36 show an exemplary system and method for identifying and/or confirming ingestion and/or digestion of medication, such as in a medication in a solid dosage form. As shown in FIG. 34, an RFID tag device 700 is attached to a medication tablet 702 prior to ingestion by a subject such as a patient 704. An external receiver and transmitter 706 receives no signal from RFID tag device 700 due to a coating layer applied to at least a portion of RFID tag device having electrically conducting or electromagnetically shielding properties that prevent or limit transmission of RF signals from RFID tag device 700. FIG. 35 shows medication tablet 702 with RFID tag device 700 after entering the patient's gastrointestinal system. Within the patient's gastrointestinal system, the coating layer is modified to allow RFID tag device 700 to emit a RF signal that is detectable by external receiver and transmitter 706 indicating or confirming that patient 704 has ingested medication tablet 702. Referring further to FIG. 36, RFID tag device 700 is broken up into fragments or pieces, such as piece 710 and piece 712, after digestion of medication tablet 702 such that a RF signal emitted from RFID tag device 700 ceases or becomes undetectable by external receiver and transmitter 706 to indicate or confirm that patient 704 has digested medication tablet 702. In one embodiment, data is recorded and external receiver and transmitter 706 monitors a timing of signals emitted by RFID tag device 700 indicating ingestion and digestion of medication tablet 702 to monitor patient compliance, for example.

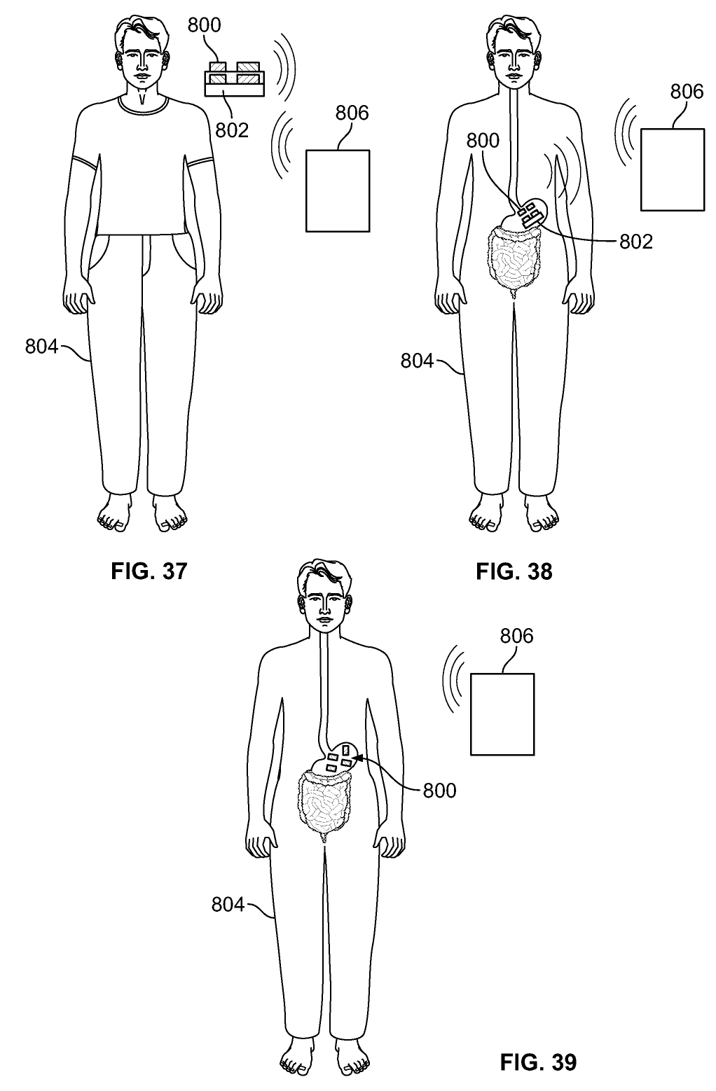

FIGS. 37-39 show an alternative exemplary system and method for identifying and/or confirming ingestion and/or digestion of medication, such as a medication in a solid dosage form. FIG. 37 shows one or more RFID tag devices 800 attached to a medication tablet 802 prior to ingestion by a subject, such as a patient 804. An external receiver and transmitter 806 receives and detects a signal from one or more RFID tag devices 800 identifying medication tablet 802. FIG. 38 shows medication tablet 802 with RFID tag devices 800 after entering the patient's gastrointestinal system. A coating layer on one or more RFID tag devices 800 is modified within the patient's gastrointestinal system such that external receiver and transmitter 806 receives and detects a RF signal transmitted to external receiver and transmitter 806 by one or more RFID tag devices 800 indicating or confirming that the patient has ingested medication tablet 802. One or more RFID tag devices 800 are modified such that external receiver and transmitter 806 receives and detects a RF signal transmitted by one or more RFID tag devices 800 or receives no signal from RFID tag devices 800, indicating or confirming that patient 804 has digested medication tablet 802. In a particular embodiment, data is recorded and external receiver and transmitter 806 monitors a timing of signals emitted by RFID tag device 800 indicating or confirming ingestion and/or digestion of medication tablet 802 to monitor patient compliance, for example.

In one embodiment, a system for monitoring ingestion and/or digestion of medicine includes one or more antennas formed on a substrate. One or more radio frequency identification (RFID) tags including at least one antenna are formed on the substrate. The RFID tag may be passive or active. In a particular embodiment, one or more of RFID tags are attached or coupled to or at least partially in an outer surface of a medication in a solid dosage form, such as a medication capsule, tablet, or pill. An LC circuit is formed on the solid dosage form. In a particular embodiment, a capacitance of the LC circuit is variable in response to a surrounding environmental condition, such as pressure, temperature, pH, and/or other chemical environmental conditions. Signals and/or power generated by an external receiver are received by the RFID tag. Signals generated by the RFID tag are transmitted to an external receiver. The signals transmitted by the RFID tag are monitored by an external monitoring system. In one embodiment, the external monitoring system includes an external receiver and transmitter.

In one embodiment, the substrate is physically and/or chemically modified after the medication has entered the patient's gastrointestinal system, thereby altering one or more characteristics of the antenna coupled to a corresponding RFID tag such that if the RFID tag is interrogated after the medication has entered the gastrointestinal system, the substrate modification results in a response signal from the RFID tag that indicates or confirms that the medication has entered the gastrointestinal system. In a particular embodiment, the antenna characteristics of the RFID tag are modified such that if the RFID tag is interrogated after the medication has dispersed in the gastrointestinal system, the substrate modification results in a response signal from the RFID tag that indicates that the medication has dispersed in the gastrointestinal system. The substrate detaches from the RFID tag upon entering the gastrointestinal system. In a particular embodiment, the substrate detaches from the RFID tag after the medication has dispersed in the gastrointestinal system.

Further, the substrate is modified to alter the electrically conducting or electromagnetically shielding properties of the substrate upon entering the gastrointestinal system, such as after the medication has dispersed in the gastrointestinal system. In a particular embodiment, the substrate is modified to swell or shrink in at least one physical dimension upon entering the gastrointestinal system, such as after the medication has dispersed in the gastrointestinal system. Additionally or alternatively, the substrate dissolves or disintegrates upon entering the gastrointestinal system, such as after the medication has dispersed in the gastrointestinal system. In a further alternative embodiment, the substrate modification causes the breakup of the RFID tag.

In one embodiment, the antenna is physically or chemically modified after the medication has entered the gastrointestinal system, thereby altering the antenna characteristics of the RFID tag such that if the RFID tag is interrogated after the medication has entered the gastrointestinal system, the antenna modification results in a response signal of the RFID tag that indicates that the medication has entered the gastrointestinal system and/or that the medication has dispersed in the gastrointestinal system. The antenna is modified to alter the electrically conducting properties of the antenna upon entering the gastrointestinal system, such as when the medication has dispersed in the gastrointestinal system. In a particular embodiment, the antenna is modified to swell or shrink in at least one physical dimension upon entering the gastrointestinal system, such as when the medication has dispersed in the gastrointestinal system. Further, the antenna may dissolve or disintegrate upon entering the gastrointestinal system, such as when the medication has dispersed in the gastrointestinal system, such that the antenna modification causes the breakup of the RFID tag.

In one embodiment, one or more coating layers are formed on the RFID tag. Further, one or more interfacial layers may be deposited on at least a portion of the substrate, at least a portion of the RFID tag and/or at least a portion of the antenna. In a particular embodiment, at least one of the coating layers is electrically conducting or electromagnetically shielding to alter the antenna characteristics of the RFID tag such that if the RFID tag is interrogated before the medication enters the gastrointestinal system, the response signal of the RFID tag is sufficiently altered or attenuated to determine whether the medication has entered the gastrointestinal system. Further, if the RFID tag is interrogated after the medication has entered the gastrointestinal system, one or more coating layers are modified such that a response signal of the RFID tag indicates that the medication has entered the gastrointestinal system. In one embodiment, the coating layers detach from the RFID tag upon entering the gastrointestinal system or are modified to alter the electrically conducting or electromagnetically shielding properties of the coating layers upon entering the gastrointestinal system. In one embodiment, the coating layers are modified to swell or shrink in at least one physical dimension or dissolve or disintegrate upon entering the gastrointestinal system. The modification of one or more of the coating layers causes the RFID tag to break up.

In one embodiment, at least one coating layer is electrically conducting or electromagnetically shielding to alter the antenna characteristics of the corresponding RFID tag such that if the RFID tag is interrogated before the medication has dispersed in the gastrointestinal system, the response signal of the RFID tag is sufficiently altered or attenuated to determine whether the medication has dispersed in the gastrointestinal system. If the RFID tag is interrogated after the medication has dispersed in the gastrointestinal system, at least one coating layer is modified such that the response signal of the RFID tag indicates that the medication has dispersed in the gastrointestinal system. In this embodiment, the coating layer detaches from the RFID tag after the medication has dispersed in the gastrointestinal system. The coating layer is modified to alter the electrically conducting or electromagnetically shielding properties of the coating layer after the medication has dispersed in the gastrointestinal system. The coating layer may be modified to swell or shrink in at least one physical dimension or dissolve or disintegrate after the medication has dispersed in the gastrointestinal system. The modification of the coating layer causes the corresponding RFID tag to break up.

In a particular embodiment, the coating layer is physically or chemically modified after the medication has entered the gastrointestinal system. The modification alters the antenna characteristics of the RFID tag such that if the RFID tag is interrogated after the medication has entered the gastrointestinal system, the coating layer modification results in a response signal of the RFID tag that indicates that the medication has entered the gastrointestinal system. The coating layer detaches from the RFID tag upon entering the gastrointestinal system. In one embodiment, the coating layer is modified to alter the electrically conducting or electromagnetically shielding properties of the coating layer upon entering the gastrointestinal system. In one embodiment, the coating layer is modified to swell or shrink in at least one physical dimension upon entering the gastrointestinal system. In a particular embodiment, the coating layer dissolves or disintegrates upon entering the gastrointestinal system. The modification of the coating layers causes the RFID tag to break up.

In one embodiment, at least one coating layer is physically or chemically modified after the medication has dispersed in the gastrointestinal system to alter the antenna characteristics of the RFID tag such that if the RFID tag is interrogated after the medication has dispersed in the gastrointestinal system, modification of the coating layer results in a response signal of the RFID tag that indicates that the medication has dispersed in the gastrointestinal system. In a particular embodiment, the coating layer detaches from the RFID tag after the medication has dispersed in the gastrointestinal system. The coating layer is modified to alter the electrically conducting or electromagnetically shielding properties of the coating layers after the medication has dispersed in the gastrointestinal system. The coating layer is modified to swell or shrink in at least one physical dimension or dissolve or disintegrate after the medication has dispersed in the gastrointestinal system. The coating layer modification causes the RFID tag to break up.

A method for monitoring ingestion and/or digestion of medicine including the system described above includes forming one or more antennas on a layer of material. One or more RFID tags including at least one antenna are formed. The RFID tags are attached or coupled to a medication in a solid dosage form, such as a medication capsule, tablet, or pill. In a particular embodiment, the RFID tags are at least partially embedded into an outer surface of the solid dosage form. In one particular embodiment, the RFID tag is only partially embedded within the outer surface. Each RFID tag is electrically coupled to and in signal communication with an external transmitter and receiver. The RFID tag receives power and/or interrogation signals from the external transmitter and receiver and generates and transmits signals to the external transmitter and receiver. The signals generated by the RFID tags are monitored to detect a modification of the RFID signal indicating or confirming ingestion and/or digestion of the medication. The modification of the substrate and/or antenna modifies the RFID signal.

In one embodiment, the RFID tag is formed on a substrate and the substrate is attached to a medication in a solid dosage form, such as a medication capsule, tablet, pill, or other suitable carrier during a suitable printing method or process including, without limitation, a screen printing, impact printing, stamping, roll-to-roll printing, contact printing, and/or laminating printing process. Alternatively, the RFID tag is formed directly on or at least partially in the surface of the medication capsule, tablet, or pill. The RFID tag may be formed from a nanoparticle ink, a nanowire, or a conducting slurry, for example. The deposited material is cured or sintered with thermal radiation or electromagnetic radiation. At least one coating layer may be deposited on at least a portion of the RFID tag.

In a particular embodiment, the RFID tag is an LC circuit. The RFID tag is formed on a medication capsule, tablet, pill, or other suitable carrier during a suitable printing method or process including, without limitation, an ink jetting, screen printing, impact printing, stamping, roll-to-roll printing, contact printing, laminating, spin coating, casting, gravure printing, roll coating, gap coating, rod coating, extrusion coating, dip coating, curtain coating, and/or air knife coating process.

In one embodiment, the RFID tag is manufactured in a series of steps. A first material layer is deposited on a medication in a solid dosage form, such as a medication pill, for example. The first material layer is patterned during a suitable printing method or process including, without limitation, an ink jetting, screen printing, impact printing, stamping, roll-to-roll printing, contact printing, spin coating, casting, gravure printing, roll coating, gap coating, rod coating, extrusion coating, dip coating, curtain coating, air knife coating, and/or laser writing printing process. The first material layer may be cured after deposition utilizing a suitable thermal radiation or electromagnetic radiation process. A conducting material layer is deposited on the medication pill during a suitable printing method or process including, without limitation, an ink jetting, screen printing, impact printing, stamping, roll-to-roll printing, contact printing, spin coating, casting, gravure printing, roll coating, gap coating, rod coating, extrusion coating, dip coating, curtain coating, air knife coating, and/or laser writing printing process. In one embodiment, the first material layer is partially removed prior to depositing the conducting material layer. In a particular embodiment, the conducting material layer is formed from a nanoparticle ink, nanowire, or conductive slurry and cured or sintered utilizing a suitable thermal radiation or electromagnetic radiation process.

Alternatively, the capsule, tablet, or pill is directly patterned during a suitable printing method or process including, without limitation, a molding, embossing and/or laser writing process. A conducting material layer is then deposited on the capsule, tablet, or pill. The conducting material is cured or sintered utilizing a suitable with thermal radiation or electromagnetic radiation process.

In a further embodiment, multiple layers of RFID tags are formed on the medication. One or more RFID tags signal the presence of the medication, one or more RFID tags signal the ingestion of the medication, and/or one or more RFID tags signal digestion of the medication. In a particular embodiment, the antenna is wrapped around the medication capsule, tablet, or pill.

In one embodiment, the external transmitter and receiver also communicates with medical devices implanted within the patient. Alternatively, a second external transmitter and/or receiver communicates with implanted medical devices. In a particular embodiment, the implanted medical device wirelessly monitors physiological conditions and/or signals within the heart, for example. In this embodiment, the medication ingestion time, the medication digestion time, and the physiological conditions and/or signals within the heart prior to, during, and/or after ingestion and/or digestion of medication are monitored. The monitored data is utilized to facilitate verifying treatment and/or changing treatment.

In one embodiment, a method for monitoring ingestion and/or digestion by a subject of a solid dosage form includes attaching a radio frequency identification (RFID) tag to a solid dosage form and detecting a change in a signal generated by the RFID tag after ingestion of the solid dosage form. In a particular embodiment, the RFID tag is at least partially embedding into the outer surface of the solid dosage form. The signal generated by the RFID tag may be detected prior to ingestion by the subject of the solid dosage form. In a particular embodiment, a reduction in a strength of the signal after ingestion of the solid dosage form is detected. The detection may include detecting the signal generated by the RFID tag after ingestion of the solid dosage form and detecting an absence of the signal after a period of time with the solid dosage form in a gastrointestinal system of the subject. The generated signal is then transmitted to an external receiver, wherein the external receiver is configured to monitor a strength of the signal. Further, the RFID tag may receive by one or more interrogation signals from an external transmitter.

In one embodiment wherein one or more coating layers are formed on the RFID tag, the coating layer(s) is electrically conducting or electromagnetic shielding to alter the signal generated by the RFID tag. Upon interrogation of the RFID tag, a first response signal generated by the RFID tag is detected to confirm that the solid dosage form has not entered a gastrointestinal system of the subject and, a second response signal generated by the RFID tag is detected to confirm that the solid dosage form has entered the gastrointestinal system wherein the coating layer(s) separates from the RFID tag.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A radio frequency identification (RFID) tag device for monitoring at least one of ingestion and digestion by a subject of a solid dosage form, the RFID tag device comprising:
a substrate one of attachable to the solid dosage form and at least partially embedded into an outer surface of the solid dosage form; and
an RFID tag at least partially formed on the substrate, the RFID tag configured to generate a signal and transmit the generated signal to an external receiver to facilitate monitoring at least one of ingestion and digestion by the subject of the solid dosage form.

2. An RFID tag device in accordance with claim 1 further comprising at least one coating layer applied to at least a portion of the RFID tag.

3. An RFID tag device in accordance with claim 2 wherein the at least one coating layer is one of electrically conducting and electromagnetic shielding to alter the generated signal to facilitate detection of the RFID tag.

4. An RFID tag device in accordance with claim 2 wherein the at least one coating layer disassociates from the RFID tag to indicate ingestion of the solid dosage form.

5. An RFID tag device in accordance with claim 2 further comprising at least one interfacial layer deposited onto at least one of the RFID tag and the at least one coating layer.

6. An RFID tag device in accordance with claim 1 wherein the substrate is one of electrically conducting and electromagnetic shielding to alter the generated signal to facilitate detection of the RFID tag.

7. An RFID tag device in accordance with claim 6 wherein the substrate detaches from the RFID tag within a gastrointestinal system of the subject to facilitate indicating at least one of ingestion and digestion by the subject of the solid dosage form.

8. An RFID tag device in accordance with claim 1 wherein the RFID tag is at least partially formed directly on the solid dosage form.

9. A system for monitoring at least one of ingestion and digestion by a subject of a solid dosage form, the system comprising:
a substrate one of attached to the solid dosage form and at least partially embedded into an outer surface of the solid dosage form; and
a radio frequency identification (RFID) tag device at least partially formed on the substrate, the RFID tag device comprising an RFID tag configured to generate a signal and transmit the generated signal to an external receiver to facilitate monitoring at least one of ingestion and digestion by the subject of the solid dosage form.

10. A system in accordance with claim 9 further comprising at least one coating layer applied to at least a portion of the RFID tag.

11. A system in accordance with claim 10 wherein the at least one coating layer is one of electrically conducting and electromagnetic shielding to alter the generated signal to facilitate detection of the RFID tag.

12. A system in accordance with claim 10 wherein the at least one coating layer disassociates from the RFID tag to indicate ingestion of the solid dosage form.

13. A system in accordance with claim 9 wherein the substrate is one of electrically conducting and electromagnetic shielding to alter the generated signal to facilitate detection of the RFID tag.

14. A system in accordance with claim 13 wherein the substrate detaches from the RFID tag within a gastrointestinal system of the subject to facilitate indicating at least one of ingestion and digestion by the subject of the solid dosage form.

15. A system in accordance with claim 9 wherein the RFID tag is at least partially formed directly on the solid dosage form.

16. A system in accordance with claim 15 wherein the RFID tag is one of formed on the solid dosage form and at least partially embedded into the outer surface of the solid dosage form using one of an ink jetting, screen printing, impact printing, stamping, roll-to-roll printing, contact printing, spin coating, casting, gravure printing, roll coating, gap coating, rod coating, extrusion coating, dip coating, curtain coating, and air knife coating process.

17. A system in accordance with claim 9 wherein the substrate is wrapped around the solid dosage form.

18. A method for monitoring at least one of ingestion and digestion by a subject of a solid dosage form, the method comprising:
attaching a radio frequency identification (RFID) tag to a solid dosage form; and
detecting a change in a signal generated by the RFID tag after ingestion of the solid dosage form.

19. A method for manufacturing a solid dosage form for monitoring at least one of ingestion and digestion by a subject of the solid dosage form, the method comprising:
forming an antenna on a substrate;
forming a radio frequency identification (RFID) tag including the antenna, the RFID tag configured to receive interrogation signals from an external transmitter and generate a response signal that is transmitted to an external receiver such that the response signal can be monitored; and
attaching the substrate to the solid dosage form or partially embedding the substrate into an outer surface of the solid dosage form.

20. A method in accordance with claim 19 further comprising forming a coating layer on at least a portion of the RFID tag, wherein the coating layer is one of electrically conducting and electromagnetic shielding to alter the response signal such that if the RFID tag is interrogated before the solid dosage form enters a gastrointestinal system of the subject, a first response signal generated by the RFID tag is detectable to confirm that the solid dosage form has not entered the gastrointestinal system and such that if the RFID tag is interrogated after the solid dosage form enters the gastrointestinal system, the coating layer separates from the RFID tag such that a second response signal generated by the RFID tag is detectable to confirm that the solid dosage form has entered the gastrointestinal system.

21. A method in accordance with claim 19 wherein the substrate is one of electrically conducting and electromagnetic shielding to alter the response signal such that if the RFID tag is interrogated before the solid dosage form has dispersed in a gastrointestinal system of the subject, a first response generated by the RFID tag is detectable to confirm that the solid dosage form has not dispersed in the gastrointestinal system and such that if the RFID tag is interrogated after the solid dosage form has dispersed in the gastrointestinal system, the substrate separates from the RFID tag such that a second response signal generated by the RFID tag is detectable to confirm that the solid dosage form has dispersed in the gastrointestinal system.

22. A method in accordance with claim 19 further comprising depositing an interfacial layer on at least one of the substrate, the antenna and a coating layer formed on at least a portion of the RFID tag.

23. A method in accordance with claim 19 wherein the substrate is attached to the solid dosage form using a printing process.

24. A method in accordance with claim 19 wherein a portion of the antenna is formed directly on the solid dosage form.

25. A method in accordance with claim 19 wherein the antenna is one of formed on the solid dosage form and at least partially embedded into the outer surface of the solid dosage form using one of an ink jetting, screen printing, impact printing, stamping, roll-to-roll printing, contact printing, spin coating, casting, gravure printing, roll coating, gap coating, rod coating, extrusion coating, dip coating, curtain coating, and air knife coating process.

26. A method in accordance with claim 19 further comprising:
depositing a first material layer on the solid dosage form;
patterning the first material layer; and
depositing a conducting material layer on the solid dosage form.

27. A method in accordance with claim 26 further comprising removing at least a portion of the first material layer prior to depositing the conducting material layer.

28. A method in accordance with claim 26 wherein the first material layer is patterned using one of an ink jetting, screen printing, impact printing, stamping, roll-to-roll printing, contact printing, spin coating, casting, gravure printing, roll coating, gap coating, rod coating, extrusion coating, dip coating, curtain coating, air knife coating, and laser writing process.

29. A method in accordance with claim 26 further comprising curing the first material layer after depositing the first material layer on the solid dosage form using one of thermal radiation and electromagnetic radiation.

30. A method in accordance with claim 26 wherein the conducting material layer is deposited on the solid dosage form using one of an ink jetting, screen printing, impact printing, stamping, roll-to-roll printing, contact printing, spin coating, casting, gravure printing, roll coating, gap coating, rod coating, extrusion coating, dip coating, curtain coating, air knife coating, and laser writing process.

31. A method in accordance with claim 19 further comprising wrapping the antenna about at least a portion of the solid dosage form.

32. A method in accordance with claim 19 wherein the solid dosage form is directly patterned using one of a molding, embossing, and laser writing process, and the conducting material layer is deposited on the solid dosage form.

33. A method in accordance with claim 19 wherein attaching the substrate to the solid dosage form further comprises at least partially embedding the substrate into the outer surface of the solid dosage form.
